(19) United States
(12) Patent Application Publication
(10) Pub. No.: US 2008/0138679 A1
(43) Pub. Date: Jun. 12, 2008

(54) Hydrogen Generation Device and Fuel Cell System Including Same

(75) Inventors: Masahiko Iijima, Saitama-ken (JP); Satoshi Iguchi, Shizuoka-ken (JP); Satoshi Shiokawa, Shizuoka-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/885,670

(22) PCT Filed: Apr. 4, 2006
(86) PCT No.: PCT/IB2006/000777

§ 371 Date: Sep. 5, 2007

(30) Foreign Application Priority Data
Apr. 5, 2005 (JP) 2005-108938

(51) Int. Cl. H01M 8/18

(52) U.S. Cl. 429/19

(57) ABSTRACT

A hydrogen generation device includes a catalyst; a sulfur-trap member; a soot-trap member; a pair of reformers; and a control portion. In each reformer, a reforming reaction is carried out to generate hydrogen-containing gas using gasoline and cathode off-gas on the catalyst, and an exothermic reaction is carried out to heat the catalyst using anode off-gas and air. The control portion executes a control such that the reactant and the exothermic material are alternately supplied to each reformer, whereby the reforming reaction and the exothermic reaction are alternately carried out in each reformer. A fuel cell system includes the hydrogen generation device.

### BACKGROUND OF THE INVENTION

1. Field of the Invention

The invention relates to a hydrogen generation device that alternately generates hydrogen through a reforming reaction using a catalyst, and recovers the catalyst via a recovery reaction. The recovery reaction recovers the catalyst by heating the catalyst for the next reforming reaction. The invention also relates to a fuel cell system that includes the hydrogen generation device.

2. Description of the Related Art

In electric vehicles, a fuel cell is provided as a power source. Hydrogen used to generate electric power in the fuel cell, or reactant used to generate hydrogen is provided

In the case where hydrogen itself is provided, it may be stored in the following ways: (i) the hydrogen gas is compressed, and stored in a high-pressure container, (ii) the hydrogen gas is liquefied and stored in a tank, or (iii) the hydrogen is provided using hydrogen storage alloy or hydrogen adsorbent. When hydrogen gas is stored in a high-pressure container as described in (i), only a small amount of hydrogen can be stored in the high-pressure container because of the thick walls and small internal volume of the container. When liquefied hydrogen is stored as described in (ii), a portion of the liquefied hydrogen is lost due to vaporization, and a great amount of energy is expended in liquefying hydrogen. When hydrogen is provided using the hydrogen storage alloy or the hydrogen adsorbent as described in (iii), the density of stored hydrogen is generally lower than that needed to power an electric vehicle. Further, controlling storage, adsorption, and the like of hydrogen is difficult.

In the case where the reactant such as methanol, and petrol, is provided, hydrogen gas may be generated through a steam-reforming reaction using the reactant. However, because the reforming reaction is an endothermic reaction, a heat source needs to be provided. Providing an electric heater or the like as the heat source in the system decreases the energy efficiency of the entire system. In addition, the system must also be able to extract the amount of hydrogen needed to power the vehicle under the various environmental conditions in which the vehicle operates.

Currently, a method for supplying hydrogen has not been technically established. However, because it is predicted that hydrogen will be used in the increasing number of devices, the method of supplying hydrogen needs to be established.

As a technology related to the above, US Patent Application Publication No. 2004/0175326 describes a fuel cell system that includes a reforming device where a reforming reaction and a recovery reaction are alternately carried out. The reforming reaction is an endothermic reaction that is carried out using reactant on a catalyst. Because the reforming reaction is an endothermic reaction, the temperature of the catalyst will decrease when the reforming reaction is carried out using the catalyst. The recovery reaction is an exothermic reaction that increases the temperature of the catalyst.

Japanese Patent Application Publication No. 2004-146337 describes a fuel cell system that includes a fuel cell using a hydrogen-permeable material, and generates electric power in a high temperature range. Also, for example, US Patent Application Publication No. 2004/0170558, US Patent Application Publication No. 2004/0170559, and US Patent Application Publication No. 2003/0235529 describe technologies related to reforming device.

In such a fuel cell system, a catalyst is used in a reformer, an electrode of a fuel cell, and the like. Therefore, if impurities (for example, soot, sulfide, and nitride) in reactant supplied or hydrogen gas generated accumulate in the reformer, resistance in gas passages in the reformer increases, and the catalyst deteriorates. As a result, the catalyst cannot function efficiently. Also, if hydrogen gas containing impurities is supplied to the fuel cell, the electrode of the fuel cell deteriorates, and ability to generate electric power decreases.

In particular, impurities in the reactant or hydrogen gas generated need to be reduced in the fuel cell system that includes the reformer where the reforming reaction and the recovery reaction are carried out alternately.

### SUMMARY OF THE INVENTION

The invention provides a hydrogen generation device in which a catalyst does not deteriorate, and the hydrogen-containing gas that is generated has few impurities. The invention provides a fuel cell system using the hydrogen generation device.

The invention relates to a hydrogen generation device where a steam-reforming reaction and a recovery reaction are carried out alternately, and a fuel cell system using the hydrogen generation device. The steam-reforming reaction is an endothermic reaction, and is carried out using reactant. The recovery reaction is an exothermic reaction. The recovery reaction increases the temperature of a catalyst that has decreased due to the steam-reforming reaction to recover the efficiency in generating hydrogen on the catalyst by the reforming reaction.

A hydrogen generation device according to the invention includes a pair of reformers; removing means; and control means. Each of the pair of reformers includes a catalyst. In each reformer, a reforming reaction is carried out to generate hydrogen-containing gas using reactant on the catalyst, and an exothermic reaction is carried out to heat and recover the catalyst using exothermic material. The removing means is provided in at least one of the pair of reformers. The control means executes a control such that the reactant and the exothermic material are alternately supplied to each reformer, whereby the reforming reaction and the exothermic reaction are alternately carried out in each reformer.

The reforming reaction according to the invention includes the steam-reforming reaction that is an endothermic reaction, and a partial oxidation reaction that is an exothermic reaction as described below.

CnH₂ₙ₊₂+nH₂O→(2n+1)H₂+nCO (1)

CnH₂ₙ₊₂+(n/2)O₂→(n+1)H₂+nCO (2)

CO+H₂O [symbol] CO₂+H₂ (3)

CO+3H₂ [symbol] CH₄+H₂O (4)

In the reforming reaction according to the invention, the steam-reforming reaction represented by an equation (1) described above is mainly carried out.

In the hydrogen generation device according to the aforementioned aspect, the removing means is provided in each reformer. The removing means traps and removes impurities contained in the reactant and exothermic material supplied to the reformer and the gas generated by each reaction, such as a sulfur compound, nitrogen compound, and soot, using a chemical method or a physical method such as adsorption. Therefore, in the hydrogen generation device according to the aforementioned aspect, deterioration of the catalyst can be reduced by removing the impurities contained in each material supplied to the reformer. Also, the hydrogen-containing gas with few impurities can be supplied to the fuel cell and the like by removing impurities contained in the gas generated by each reaction.

In the aforementioned aspect, the reactant may be the mixture of a fuel and water vapor. The fuel may be selected among hydrocarbon fuels (for example, methane gas and gasoline) that are generally used in the reforming reaction such as the steam-reforming reaction to obtain synthetic gas of hydrogen and carbon monoxide (particularly, hydrogen gas). The water vapor in the reactant may be obtained from water vapor-containing gas that is discharged from the cathode (oxygen electrode) of the fuel cell (hereinafter, referred to as “cathode off-gas”). Alternatively, the water vapor in the reactant may be obtained by humidifying the fuel or humidifying air.

The exothermic material may be the mixture of a fuel and air. The fuel may be selected among hydrocarbon fuels (for example, methane gas and gasoline) that are generally used. Alternatively, the exothermic material may be the hydrogen-containing gas that is discharged from the anode (hydrogen electrode) of the fuel cell (hereinafter, referred to as “anode off-gas”).

In the aforementioned aspect, the removing means may remove at least one of a sulfur compound and a nitrogen compound; and the removing means may be provided upstream of the catalyst in the at least one of the pair of reformers in the direction where the reactant flows.

With this configuration, the sulfur compound contained in the reactant can be removed before the sulfur compound reaches the catalyst. This reduces the possibility that the catalyst deteriorates due to poisoning with the sulfur compound.

In the aforementioned aspect, the removing means may remove at least soot; and the removing means may be provided downstream of the catalyst in the at least one of the pair of reformers in the direction where the reactant flows.

With this configuration, soot that is generated by the partial oxidation reaction of the reactant and the like can be removed before it is discharged from the reformer. Therefore, the hydrogen-containing gas that has a low content of soot can be generated. This reduces the possibility that soot is delivered to the fuel cell and the like. Also, in the case where the exothermic material is supplied in the direction opposite to the direction where the reactant is supplied when the recovery reaction (exothermic reaction) is carried out, soot trapped by the removing means reacts with the exothermic material, and the combustion reaction is carried out. This increases the amount of stored heat to carry out the reforming reaction.

In the aforementioned aspect, the removing means includes a first removing means and a second removing means, the first removing means may remove at least one of a sulfur compound and a nitrogen compound; and the first removing means may be provided upstream of the catalyst in the at least one of the pair of reformers in the direction where the reactant flows, and the second removing means may remove at least soot; and the second removing means may be provided downstream of the catalyst in the at least one of the pair of reformers in the direction where the reactant flows.

In the hydrogen generation device according to the aforementioned aspect, the control means may execute a control such that when the reforming reaction is carried out in one of the pair of reformers, the exothermic reaction is carried out in the other reformer.

In the hydrogen generation device according to the invention, a pair of reformers (hereinafter, will be sometimes referred to as “pressure swing reforming (PSR) reformers”) is provided. In each of the reformers, the steam-reforming reaction for generating hydrogen and the exothermic reaction (recovery reaction) can be carried out alternately. The steam-reforming reaction is carried out using stored heat. The exothermic reaction (recovery reaction) increases the amount of stored heat that has decreased due to the steam-reforming reaction. The reforming reaction for generating hydrogen is carried out in one reformer, and the recovery reaction is carried out in the other reformer (hereinafter, the hydrogen generation device will be sometimes referred to as “PSR device”).

For example, in the case where two reformers are provided, the steam-reforming reaction that is the endothermic reaction is carried out using stored heat in one of the reformers, and the recovery reaction that is the exothermic reaction is carried out in the other reformer. If the amount of stored heat decreases due to the reforming reaction in one reformer, the passages through which the reactant and the exothermic material are supplied to the two reformers are changed so that the reforming reaction switches to the recovery reaction in the one reformer, and the recovery reaction switches to the reforming reaction in the other reformer. Accordingly, a heater or the like does not need to be provided, and hydrogen can be continuously generated while using heat energy efficiently.

A fuel cell system according to the invention may include the hydrogen generation device according to the invention, and a fuel cell that generates electric power using hydrogen-containing gas that is generated by the hydrogen generation device.

With this configuration, hydrogen-containing gas that has few impurities can be supplied to the fuel cell from the reformers. This reduces the possibility that the performance of the fuel cell deteriorates due to impurities.

In the fuel cell system according to the aforementioned aspect, the fuel cell may include a hydrogen-permeable metal layer, and an electrolyte layer that is provided on at least one surface of the hydrogen-permeable metal layer.

In the case where the fuel cell includes the hydrogen-permeable metal layer and the electrolyte layer, the operating temperature range of the fuel cell is 300° C. to 600° C. This operating temperature range is substantially the same as the reaction temperature range of the reforming reaction. Therefore, the temperature of the hydrogen-containing gas that is generated by the hydrogen generation device is in the operating temperature range of the fuel cell. Also, the anode off-gas can be delivered to the PSR reformers without adjusting the temperature of the gas, and can be used in the recovery reaction and the like. Therefore, this fuel cell is suitable for the fuel cell system, and heat can be effectively used in the fuel cell system.

A hydrogen generation device according to the invention includes a plurality of reformers; removing means; and control means. Each of the plurality of reformers includes a catalyst. In each reformer, a reforming reaction is carried out to generate hydrogen-containing gas using reactant on the catalyst, and an exothermic reaction is carried out to heat and recover the catalyst using exothermic material. The removing means is provided in at least one of the plurality of reformers. The control means executes a control such that the reactant and the exothermic material are alternately supplied to each reformer, whereby the reforming reaction and the exothermic reaction are alternately carried out in each reformer.

In the hydrogen generation device and the fuel cell system that includes the hydrogen generation device according to the aforementioned aspect, the catalyst does not deteriorate, and hydrogen-containing gas that has few impurities can be generated.

### BRIEF DESCRIPTION OF THE DRAWINGS

The foregoing and/or further objects, features and advantages of the invention will become more apparent from the following description of example embodiments with reference to the accompanying drawings, in which the same or corresponding portions are denoted by the same reference numerals and wherein:

FIG. 1 illustrates a schematic diagram showing the configuration of a fuel cell system according to a first embodiment of the invention;

FIG. 2 illustrates a schematic cross sectional view showing the configuration of a reformer;

FIG. 3 illustrates a cross sectional view showing a fuel cell according to the first embodiment;

FIG. 4 illustrates a diagram explaining the control of valves;

FIG. 5 illustrates a flowchart of a control to switch a reforming reaction to a recovery reaction in a reformer 112;

FIG. 6 illustrates a cross sectional view showing another example of the fuel cell according to the invention; and

FIG. 7 illustrates a cross sectional view showing yet another example of the fuel cell according to the invention.

### DETAILED DESCRIPTION OF THE EXAMPLE EMBODIMENTS

Hereinafter, a fuel cell system according to an embodiment of the invention will be described in detail with reference to the drawings. A hydrogen generation device according to the invention will be also described in detail in the context of description of the fuel cell system.

The fuel cell system according to the embodiment is provided in an electric vehicle. The fuel cell system includes a hydrogen membrane fuel cell (hereinafter, referred to as “HMFC”) and a hydrogen generation device according to the invention. The HMFC includes an electrolyte membrane where proton-conductive ceramic is provided on the surface of a hydrogen-permeable metal membrane.

In this embodiment, when the reforming reaction is carried out, gasoline and cathode off-gas containing water vapor are used as reactant. The cathode off-gas is discharged from the oxygen electrode (cathode) of the HMFC. A combustion reaction is carried out as the exothermic reaction (recovery reaction). When the recovery reaction is carried out, anode off-gas mixed with air is used as exothermic reaction. The anode off-gas is discharged from a hydrogen electrode (anode) of the fuel cell. However, the invention is not limited to this embodiment.

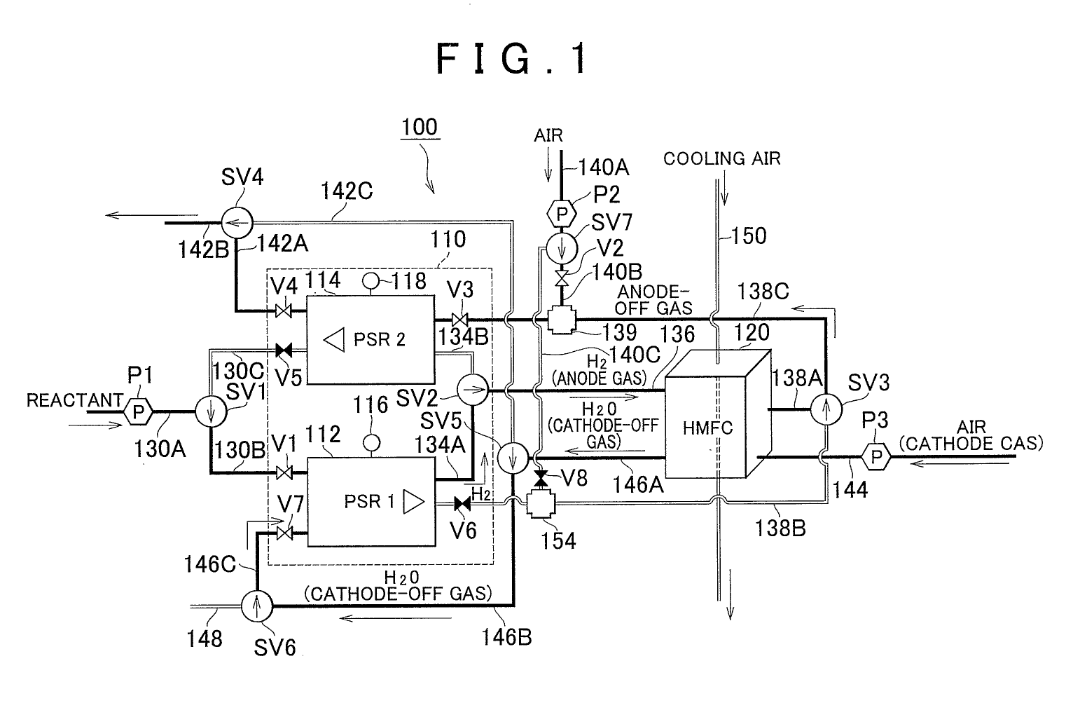

First, the basic structure of a fuel cell system according to the invention will be described with reference to FIG. 1. FIG. 1 illustrates a schematic diagram showing the configuration of the fuel cell system according to the first embodiment. In FIG. 1, a fuel cell system 100 includes a hydrogen generation device 110, and an HMFC 120. The hydrogen generation device 110 includes a reformer 112 (PSR1) and a reformer 114 (PSR2). The HMFC 120 generates electric power using hydrogen generated by the hydrogen generation device 110.

Each of the reformers 112 and 114 in FIG. 1 includes a sulfur-trap member that traps sulfur and the like; a soot-trap member that traps soot; a catalyst; and an injection device. In each of the reformers 112 and 114, the reforming reaction and the recovery reaction are carried out alternately. The reforming reaction and the recovery reaction are switched to each other by controlling a plurality of valves (valves V1 to V8, and three-way valves SV1 to SV7). These valves switches among supply passages through which gasoline and the cathode off-gas are supplied to the reformers, among supply passages through which the anode off-gas and air are supplied to the reformers, among discharge passages through which hydrogen-containing gas that is generated by the reforming reaction is discharged, and among passages through which gas generated by the recovery reaction is discharged from the reformers. More specifically, the valves V1 to V8 permit gas to flow through the passages. Each of the three-way valves SV1 to SV7 is connected to three pipes, and permits communication between any two of the three pipes.

In the fuel cell system 100 according to the invention, when the steam-reforming reaction is carried out in one of the reformers, the recovery reaction is carried out in the other reformer. The steam-reforming reaction is an endothermic reaction. The temperature inside one reformer where the steam-reforming reaction is carried out is monitored. If the temperature inside the one reformer becomes lower than a predetermined temperature, the reforming reaction is switched to the recovery reaction in the one reformer, and the recovery reaction is switched to the reforming reaction in the other reformer. More specifically, instead of gasoline and the cathode off-gas that serve as reactant, the anode off-gas and air are supplied to the one reformer so that the reaction in the reformer is changed from the reforming reaction to the recovery reaction. Instead of the anode off-gas and air, gasoline and the cathode off-gas are supplied to the other reformer so that the reaction in the reformer is changed to the reforming reaction. Gasoline and the cathode off-gas that serve as reactant are supplied to each reformer in the direction opposite to the direction where the anode off-gas and air are supplied, taking into account the temperature gradient inside each reformer.

When a fuel cell system 100 operates, the reforming reaction and the recovery reaction are carried out alternately in each reformer. However, for simplicity of description, the reforming reaction is carried out in the reformer 112 and the recovery reaction is carried out in the reformer 114 in this embodiment.

The basic structure of the fuel cell system according to the invention will be described. As shown in FIG. 1, a supply pipe 130B is connected to one side of the reformer 112, and a supply pipe 130C is connected to one side of the reformer 114. The supply pipes 130B and 130C are connected to a supply pipe 130A via the three-way valve SV1. Reactant is supplied to the reformers through these pipes. Hereinafter, the term “upstream” and “downstream” signify the upstream and downstream in the direction where the reactant flows. The supply pipe 130A is provided with a pump P1. By operating the pump P1, gasoline that serves as reactant is supplied to the reformer 112. The supply pipes 130B and 130C are provided with valves V1 and V5, respectively. Further, the reformers 112 and 114 are provided with temperature sensors 116 and 118, respectively. The temperature sensors 116 and 118 detect the temperature inside the reformers 112 and 114, respectively.

An end of a discharge pipe 134A is connected to the other side of the reformer 112, and an end of a discharge pipe 134B is connected to the other side of the reformer 114. Hydrogen-containing gas is discharged through the discharge pipes 134A and 134B. When the combustion reaction (recovery reaction) is carried out, the anode off-gas is supplied to the reformers from the downstream side.

The other ends of the discharge pipes 134A and 134B are connected to the three-way valve SV2. An end of a supply pipe 136 is also connected to the three-way valve SV2. By changing the state of the three-way valve SV2, communication is permitted between the supply pipe 136 and the discharge pipe 134A or 134B.

The other end of the supply pipe 136 is connected to one side of the anode of the HMFC 120. The hydrogen-containing gas is supplied to the HMFC 120 through the supply pipe 136. One end of a discharge pipe 138A is connected to the other side of the anode of the HMFC 120. After the hydrogen-containing gas is used in the anode, all of the gas (anode off-gas) is discharged through the discharge pipe 138A. The other side of the discharge pipe 138A is connected to the three-way valve SV3. By changing the state of the three-way valve SV3, communication is permitted between the discharge pipe 138A and a discharge pipe 138B or 138C.

The other end of the discharge pipe 138C is connected to the downstream side of the reformer 114 so that the anode off-gas discharged from the HMFC 120 is supplied to the reformer 114. The discharge pipe 138C is provided with a mixer 139 that is connected to a supply pipe 140B. The supply pipe 140B is connected to a supply pipe 140A via the three-way valve SV7. Air is supplied through the supply pipes 140A and 140B. The supply pipe 140B is provided with the valve V2. By operating the valve V2 and a pump P2, air is supplied to the mixer 139. In the mixer 139, the anode off-gas discharged from the HMFC 120 is mixed with air supplied through the supply pipe 140B. The anode off-gas mixed with air is supplied to the reformer 114. The discharge pipe 138C is provided with the valve V3. Further, the three-way valve SV7 is connected to an end of a supply pipe 140C. Air is supplied through the supply pipe 140C.

A discharge pipe 142A is connected to the upstream side of the reformer 114. Gas generated by the oxidation reaction is discharged to the outside of the fuel cell system through the three-way valve SV4 and a discharge pipe 142B. Also, the discharge pipe 142A and the supply pipe 130C, which are connected to the upstream side of the reformer 114, are provided with the valves V4 and V5, respectively.

The three-way valve SV4 permits communication between the discharge pipe 142A and the discharge pipe 142B or 142C. The other end of the discharge pipe 142C is connected to the three-way valve SV5.

The discharge pipe 138B is provided with the valve V6. Further, the other end of the discharge pipe 138B is connected to the downstream side of the reformer 112. Also, the pipe 138B is provided with a mixer 154 that is connected to the other end of the supply pipe 140C. Further, the supply pipe 140C is provided with the valve V8.

One end of a supply pipe 144 is connected to one side of the cathode (oxygen electrode) of the HMFC 120. The supply pipe 144 is provided with a pump P3. Air and the like are supplied to the cathode through the supply pipe 144. One end of a supply pipe 146A is connected to the other side of the cathode of the HMFC 120. The cathode off-gas is discharged through the supply pipe 146A.

The three-way valve SV5 is provided at the other end of the supply pipe 146A. The other end of the discharge pipe 142C is connected to the three-way valve SV5. The three-way valve SV5 permits communication between the supply pipe 146A and the discharge pipe 142C or the supply pipe 146B.

The three-way valve SV6 is connected to the other end of the supply pipe 146B. The three-way valve SV6 is also connected to an end of a supply pipe 146C and an end of a discharge pipe 148. The supply pipe 146C is provided with the valve V7. The other end of the supply pipe 146C is connected to the upstream side of the reformer 112. The cathode off-gas that contains H₂O is supplied to the reformer 112 through the supply pipe 146C. By changing the state of the three-way valve SV6, communication is permitted between the supply pipe 146B and the discharge pipe 148 so that the cathode off-gas is discharged to the outside of the fuel cell system through the discharge pipe 148.

A cooling pipe 150 extends through the HMFC 120. Cooling air obtained from the atmosphere is supplied through the cooling pipe 150 so that the inside of the HMFC 120 is cooled by heat exchange.

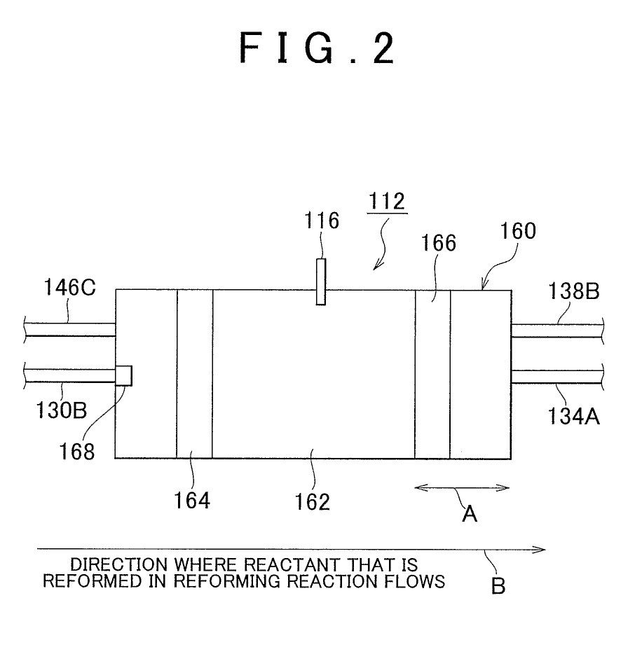

Next, the configuration of the reformer will be described. Because the reformers 112 and 114 have the same configuration, only the configuration of the reformer 112 will be described. FIG. 2 illustrates a schematic cross sectional view showing the configuration of the reformer 112. As shown in FIG. 2, the reformer 112 includes a cylindrical body 160; a catalyst (catalyst support portion) 162; a sulfur-trap member 164; and a soot-trap member 166. The cylindrical body 160 has a cross section of a circle. The both ends in the longitudinal direction of the cylindrical body 160 are closed. The catalyst 162 is supported at the inner wall surface of the cylindrical body 160. The sulfur-trap member 164 traps sulfur and the like. The soot-trap member 166 traps soot. The cylindrical body 160 has a space where the reaction is carried out, and functions as a catalyst support body.

The cylindrical body 160 is formed from ceramic honeycomb into a cylindrical shape. The cylindrical body 160 has the cross section of a circle having a diameter of 10 cm. The cylindrical body 160 is a hollow body. The both ends in the longitudinal direction of the cylindrical body 160 are closed. The cross section of the cylindrical body 160 may have any other shape such as a rectangle and an oval, according to the purpose. Also, the size of the cylindrical body 160 may be changed according to the purpose.

In a curved surface of the inner wall of the cylindrical body 160, regions having a predetermined width A at both sides in the longitudinal direction are referred to as “catalyst-free regions”. The catalyst 162 is not supported in the catalyst-free regions A. That is, the catalyst 162 is supported in the entire surface of the inner wall of the cylinder body 160, except the catalyst-free regions A. As the catalyst 162, metals such as Pd, Ni, Pt, Rh, Ag, Ce, Cu, La, Mo, Mg, Sn, Ti, Y, and Zn may be used.

When the reforming reaction is carried out at the catalyst 162, the hydrogen-containing gas that is generated by the reforming reaction is cooled at the catalyst-free region at the downstream side. Therefore, the temperature of the hydrogen-containing gas that is supplied to the HMFC 120 can be made close to the operating temperature of the HMFC 120. When the reforming reaction switches to the recovery reaction, the temperature of the catalyst-free region has been increased due to heat exchange with the hydrogen-containing gas. Therefore, the anode off-gas, which is supplied in the direction opposite to the direction where the hydrogen-containing gas is discharged, is preheated at the catalyst-free region before the anode off-gas is supplied to the catalyst 162. As a result, temperature distribution is formed such that the amount of stored heat increases toward the center of the cylindrical body 160 where the catalyst 162 is supported. This is advantageous for promoting the reaction. A temperature sensor 116 that measures the temperature of the catalyst 162 is fitted to the cylindrical body 160.

The sulfur-trap member 164 is provided at the catalyst-free region at the upstream side of the cylindrical body 160 (i.e., at the upstream side in the direction shown by an arrow B in FIG. 2). The sulfur-trap member 164 traps sulfur compounds and the like and nitrogen compounds contained in gasoline and the like. The sulfur-trap member 164 is formed using zeolite that has a porous structure. After gasoline is supplied to the reformer 112, the sulfur-trap member 164 removes sulfur compounds and the like, and then the reforming reaction is carried out using the gasoline on the catalyst 162. This reduces the possibility that the catalyst 162 deteriorates due to contact with sulfur compounds and the like. The sulfur-trap member 164 may be formed using any appropriate material that traps sulfur compounds and the like and nitrogen compounds, instead of zeolite. For example, the sulfur-trap member 164 may be formed using oxide such as activated carbon and zinc oxide, or metal such as Pt. Further, the sulfur-trap member 164 may have a filter structure or a honeycomb structure, instead of the porous structure.

The soot-trap member 166 is provided at the catalyst-free region at the downstream side of the cylindrical body 160. The soot-trap member 166 traps soot generated by the partial oxidation reaction. The soot-trap member 166 is formed using a ceramic filter. The soot-trap member 166 removes soot in the hydrogen-containing gas and the like before the hydrogen-containing gas is discharged from the downstream side of the reformer 112. This reduces the possibility that soot in the hydrogen-containing gas is delivered to the HMFC 120. The soot-trap member 166 may be formed using metal that supports Pd and the like, instead of the ceramic filter. Further, the soot-trap member 166 may have a porous structure or a honeycomb structure, instead of the filter structure.

In the embodiment of the invention, after the fuel cell system 100 is started and the warming-up operation is completed, air is supplied to the cathode of the HMFC 120 using the pump P3. Then, the cathode off-gas and gasoline are supplied to the reformer 112 to activate the fuel cell system. Because the hydrogen-containing gas has not been supplied to the HMFC 120 yet in this step, the cathode off-gas does not contain water vapor. Therefore, the proportion of gasoline becomes high in the reformer 112, which causes the partial oxidation reaction of gasoline with oxygen in air. The HMFC 120 gradually starts to generate electric power using hydrogen generated by the partial oxidation reaction. After the oxygen in gas supplied to the cathode (oxygen electrode) is consumed at the cathode, the amount of water vapor contained in the cathode off-gas increases. Then, the partial oxidation reaction switches to the steam-reforming reaction in the reformer 112.

Because the partial oxidation reaction is carried out when the fuel cell system is started as described above, soot is likely to be generated by the partial oxidation reaction. However, in the fuel cell system 100 according to the invention, the soot-trap member 166 can remove the soot generated by the partial oxidation reaction, for example, when the fuel cell system is started. This reduces the possibility that soot in the hydrogen-containing gas is delivered to the HMFC 120 from the hydrogen generation device 110, and the anode of the HMFC 120 is eroded by the soot. As a result, the HMFC 120 can stably supply electric power.

The supply pipes 130B and 146C are connected to the wall at the upstream side of the cylindrical body 160. An injection device 168 is provided at the end of the supply pipe 130B. Further, the discharge pipes 134A and 138B are connected to the wall at the downstream side of the cylindrical body 160.

When the steam-reforming reaction is carried out in the reformer 112 during the ordinary operation, the injection device 168 injects gasoline that serves as reactant in a wide range. Gasoline injected by the injection device 168 and water vapor contained in the cathode off-gas are supplied to the catalyst 162 provided in the cylindrical body 160 so that the reforming reaction is carried out. The hydrogen-containing gas that is generated by the steam-reforming reaction is discharged through the discharge pipe 134A and is supplied to the HMFC 120.

When the reforming reaction switches to the recovery reaction in the reformer 112, anode off-gas is supplied to the catalyst 162 so that the oxidation reaction is carried out. The anode off-gas may be supplied along with gasoline and the hydrogen-containing gas, if necessary.

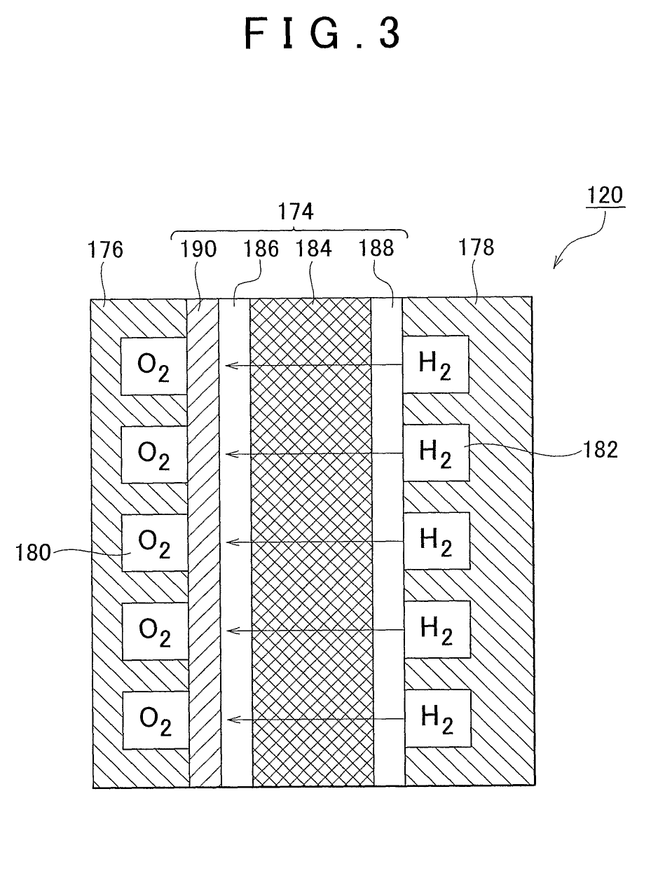

Next, the HMFC 120 will be described with reference to FIG. 3. FIG. 3 illustrates a cross sectional view showing the HMFC 120 according to the embodiment. As shown in FIG. 3, the HMFC 120 includes an electrolyte membrane 174; an oxygen electrode 176; and a hydrogen electrode 178. The electrolyte membrane 174 includes a dense hydrogen-permeable metal membrane. The electrolyte membrane 174 is provided between the oxygen electrode 176 and the hydrogen electrode 178. When the hydrogen-containing gas generated in the hydrogen generation device 110 is supplied to the HMFC 120, hydrogen is selectively allowed to pass through the electrolyte membrane 174 so that electric power is generated.

Air passages 180 are formed between the oxygen electrode 176 and the electrolyte membrane 174. Air that serves as oxidant gas passes through the air passages 180. That is, air is supplied and discharged through the air passages 180. Hydrogen passages 182 are formed between the hydrogen electrode 178 and the electrolyte membrane 174. Hydrogen-containing gas that is generated by the reforming reaction passes through the hydrogen passages 182. That is, the hydrogen-containing gas is supplied and discharged through the hydrogen passages 182. Each of the oxygen electrode 176 and the hydrogen electrode 178 may be formed using various materials such as carbon (for example, carbon powder that supports platinum or alloy of platinum and another metal) or electrolyte solution (for example, Nafion Solution produced by Aldrich Chemical Company).

The electrolyte membrane 174 has four layers that include a dense substrate 184 made of vanadium (V). The dense substrate 184 is a dense hydrogen-permeable metal layer. The substrate 184 is provided between palladium (Pd) layers 186, 188. The Pd layers 186, 188 are dense hydrogen-permeable metal layers. A thin electrolyte layer 190 made of solid oxide (BaCeO₃) is provided on the surface of the Pd layer 186, which does not contact the substrate 184.

The substrate 184 may be formed using niobium, tantalum, or an alloy containing at least one of niobium and tantalum, instead of vanadium (V). They have high hydrogen permeability, and are not expensive.

The electrolyte layer 190 may be formed using an SrCeO₃-based ceramic proton conductor, instead of BaCeO₃.

Examples of hydrogen-permeable metal include palladium, vanadium, niobium, tantalum, alloy containing at least one of vanadium, niobium, and tantalum, and palladium alloy. By providing the dense layers made of such hydrogen-permeable metal, the electrolyte layer can be protected.

Preferably, the dense layer (coating) near the oxygen electrode 176 is formed using vanadium (vanadium itself or a vanadium alloy such as vanadium-nickel), niobium, tantalum, or alloy containing at least one of niobium and tantalum, because these metals have high hydrogen permeability and are not expensive in general. The dense layer near the hydrogen electrode 178 can be formed using any one of these metals. However, these metals may cause hydrogen embrittlement. Therefore, preferably, the dense layer near the hydrogen electrode 178 is formed using palladium or palladium alloy. Palladium and palladium alloy have high hydrogen permeability and are unlikely to cause hydrogen embrittlement.

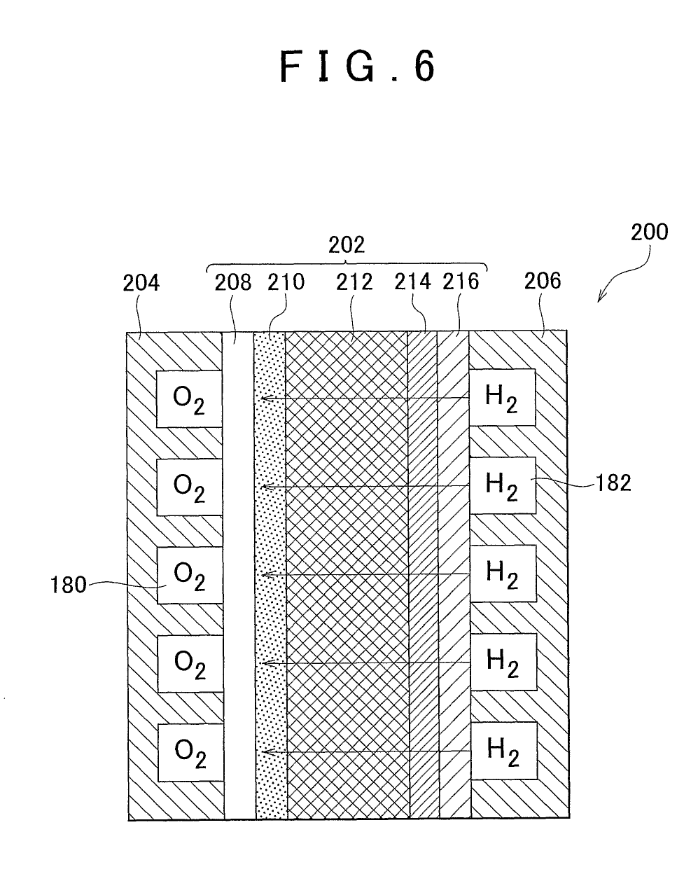

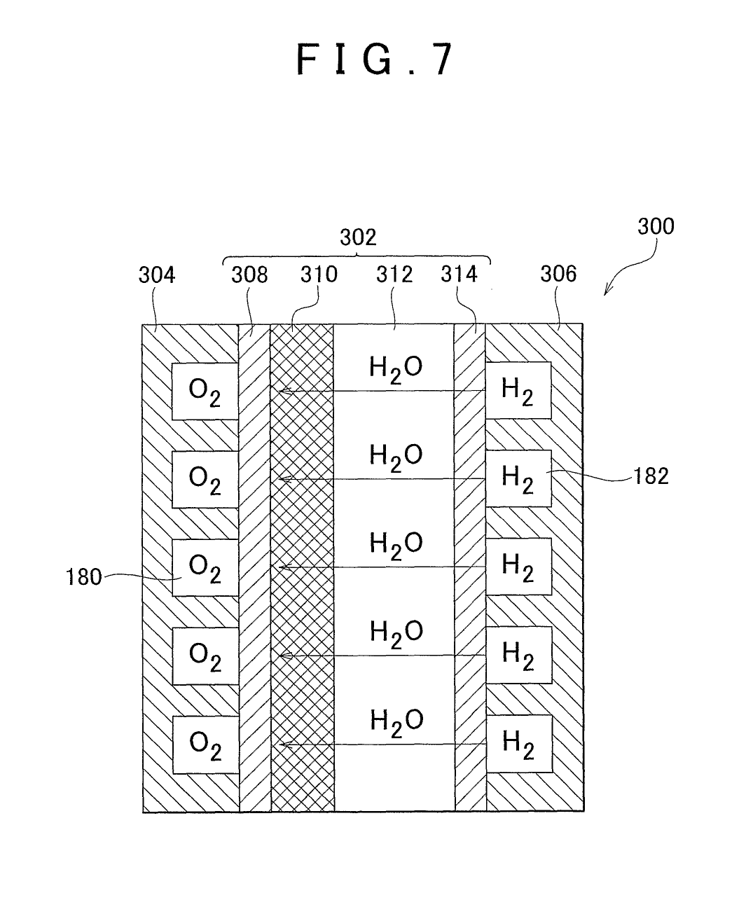

In the case where the Pd layer 186, the substrate 184, and the Pd layer 188 are stacked, that is, two or more layers made of different metals (dense hydrogen-permeable metal layers) are stacked as shown in FIG. 3, a metal-diffusion suppression layer that suppresses diffusion of different metal ions may be provided in at least a portion of an interface between the different metals (refer to FIG. 6 and FIG. 7 described later). The metal-diffusion suppression layer is described in the paragraphs [0015] to [0016] in Japanese Patent Application Publication No. JP-A-2004-146337.

Instead of stacking the palladium layer (Pd layer), the vanadium layer (V layer), and the palladium layer (Pd layer) as described above, five layers may be stacked. For example, the Pd layer, a tantalum layer (Ta layer), a V layer, a Ta layer, and a Pd layer may be stacked in the order stated. As described above, the speed at which protons or hydrogen atoms pass through vanadium is higher than the speed at which protons or hydrogen atoms pass through palladium. Also, vanadium is less expensive than palladium. However, vanadium has low ability to decompose a hydrogen molecule into a proton and the like, as compared to palladium. Therefore, by providing the Pd layer that has high ability to decompose the hydrogen molecule to the proton and the like on one surface or both surfaces of the V layer, the hydrogen permeability can be increased. In this case, by providing the metal-diffusion suppression layer between the metal layers, diffusion of the different metal ions and a decrease in the hydrogen permeability can be suppressed. Accordingly, a decrease in the electromotive force of the HMFC can be suppressed.

The electrolyte layer 190 is made of a solid oxide. A reaction suppression layer that suppresses the reaction of oxygen atoms in the electrolyte layer 190 with Pd may be provided in at least a portion of the interface between the electrolyte layer 190 and the Pd layer 186 (refer to a reaction suppression layer 210 in FIG. 6 described later). The reaction suppression layer is described in the paragraphs [0024] to [0025] in Japanese Patent Application Publication No. JP-A-2004-146337.

The electrolyte membrane 174 includes the dense vanadium substrate that is hydrogen-permeable, and the inorganic electrolyte layer that is formed adjacent to the cathode of the HMFC 120. Therefore, the electrolyte membrane can be made thin. By employing this configuration, the operating temperature of a solid oxide fuel cell (SOFC), which is generally high, can be reduced to the temperature range of 300° C. to 600° C. As a result, in the fuel cell system according to the invention, the cathode off-gas discharged from the HMFC 120 can be directly supplied to the reformer where the reforming reaction is carried out.

When the hydrogen-containing gas that has high hydrogen (H₂) density is supplied to the hydrogen passages 182 and air containing oxygen (O₂) is supplied to the air passages 180, the electrochemical reactions represented by equations (1) to (3) are carried out in the HMFC 120 (that is, the fuel cell reaction is carried out), and electric power is supplied to the outside of the HMFC 120. The equation (1) represents the reaction in the anode, the equation (2) represents the reaction in the cathode, and the equation (3) represents all the reactions in the HMFC 120.

H₂→2H⁺+2e⁻ (1)

(½)O₂+2H⁺+2e⁻→H₂O (2)

H₂+(½)O₂→H₂O (3)

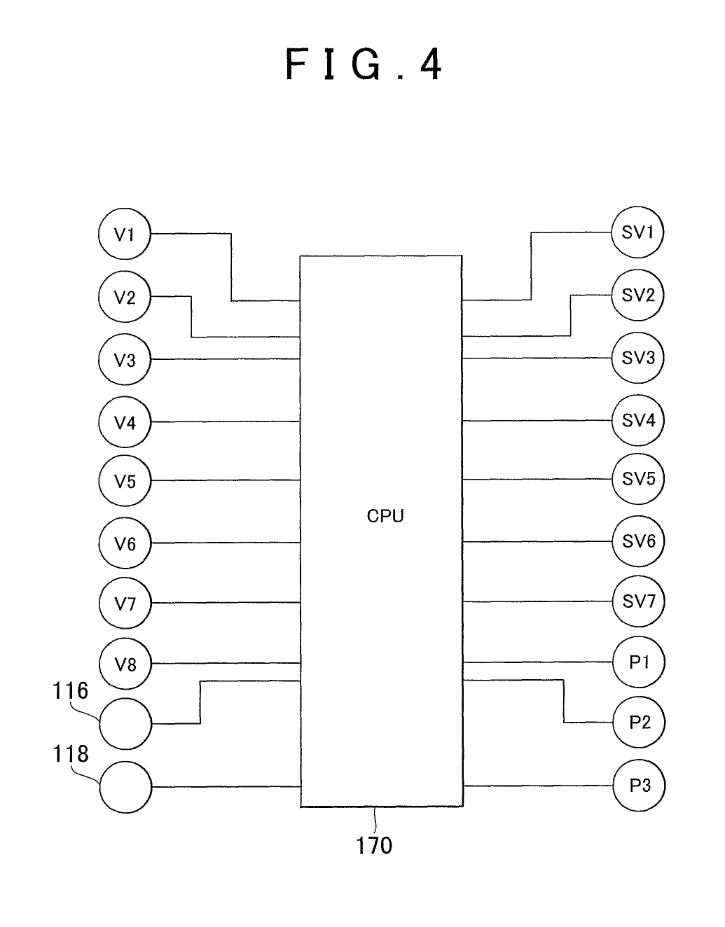

The control of the valves will be described with reference to FIG. 4. FIG. 4 illustrates a diagram explaining the control of the valves. As shown in FIG. 4, the valves V1 to V8, the three-way valves SV1 to SV7, and the pumps P1 to P3 are connected to a control portion (CPU) 170. The control portion 170 controls the valves V1 to V8, the three-way valves SV1 to SV7, and the pumps P1 to P3. The control portion 170 is also connected to the temperature sensors 116 and 118. Using the temperature sensors 116 and 118, the temperatures inside the reformers 112 and 114 can be monitored, respectively. The control portion 170 controls the valves and pumps according to the temperatures inside the reformers 112 and 114, whereby the reforming reaction can be switched to the recovery reaction (combustion reaction) in each of the reformers 112 and 114. Further, the control portion 170 controls the pumps P1 to P3, thereby controlling the amount of gasoline (reactant) supplied to the reformers, and the amount of air supplied to the HMFC 120.

Next, the flow of gas and the control of the flow of gas in the fuel cell system 100 according to the embodiment during ordinary operation will be described with reference to FIG. 1. In FIG. 1, the pipes indicated by thick lines are used in the case where the reforming reaction is carried out in the reformer 112, and the recovery reaction (combustion reaction) is carried out in the reformer 114. The pipes indicated by outlines are not used in this case. Among the valves V1 to V8, the valves indicated by outlines are open, and black valves are closed.

In FIG. 1, first, gasoline is supplied through the supply pipe 130A by operating the pump P1. The three-way valve SV1 permits communication between the supply pipes 130A and 130B, and gasoline is supplied to the reformer 112 through the supply pipe 130B. In this embodiment, water vapor in the cathode off-gas from the HMFC 120 is used in the reforming reaction. However, water vapor may be supplied into the fuel cell system from the outside of the system, along with gasoline or separately from gasoline.

When gasoline and water vapor in the cathode off-gas passes through the sulfur-trap member 164 in the reformer 112 in FIG. 2, the sulfur-trap member 164 mainly removes the sulfur compounds from gasoline. Then, the gasoline and water vapor reach the catalyst, and hydrogen-containing gas is generated on the catalyst by the steam-reforming reaction. The hydrogen-containing gas passes through the soot-trap member 166 in FIG. 2, and is discharged through the discharge pipe 134A. At this time, the three-way valve SV2 permits communication between the discharge pipe 134A and the supply pipe 136. The hydrogen-containing gas discharged from the reformer 112 is supplied to the anode of the HMFC 120 through the discharge pipe 134A and the supply pipe 136. The HMFC 120 generates electric power using the hydrogen-containing gas.

The anode off-gas contains surplus hydrogen molecules that have not been decomposed into protons in the anode of the HMFC 120. The anode off-gas is discharged through the discharge pipe 138A. At this time, the three-way valve SV3 permits communication between the discharge pipes 138A and 138C. The anode off-gas discharged into the discharge pipe 138A is delivered to the discharge pipe 138C. The anode off-gas is supplied to the mixer 139 through the discharge pipe 138C.

At this time, the three-way valve SV7 permits communication between the supply pipes 140A and 140B so that air is supplied to the mixer 139. The valve V2 is controlled to be open.

In the mixer 139, the anode off-gas is mixed with air supplied through the supply pipes 140A and 140B to form mixed gas. Then, the mixed gas is supplied to the reformer 114. At this time, the valve V3 is controlled to be open. In the invention, an auxiliary pipe may be provided. In this case, gasoline and the like are supplied through the auxiliary pipe, and are used in the recovery reaction along with the anode off-gas.

In the reformer 114, the sulfur-trap member is provided at the upstream side, and the soot-trap member is provided at the downstream side, as in the reformer 112. The sulfur-trap member has trapped the sulfur compounds in gasoline supplied for the previous reforming reaction, and the soot-trap member has trapped soot and the like generated in the previous reforming reaction. When the anode off-gas mixed with air is supplied to the reformer 114, the soot trapped by the soot-trap member reacts with the anode off-gas, which causes the combustion reaction. This combustion reaction efficiently increases the amount of heat stored in the reformer 114. Next, the combustion reaction is caused on the catalyst using the anode off-gas. This combustion reaction also increases the amount of heat stored in the reformer 114.

The sulfur compounds and other impurities trapped by the sulfur-trap member during the reforming reaction are released from the sulfur-trap member by the heat of the combustion reaction. The sulfur compounds and the like, and the gas generated by the combustion reaction are discharged to the outside of the fuel cell system through the discharge pipes 142A and 142B, a desulfurization device (not shown), and the like. At this time, the valve V4 provided in the discharge pipe 142A is controlled to be open, and the valve V5 provided in the supply pipe 130C is controlled to be closed.

Air that serves as an oxidant is supplied to the cathode of the HMFC 120 through the supply pipe 144 by operating the pump P3. Oxygen in air supplied to the cathode reacts with protons supplied through the electrolyte membrane, and electrons supplied through an external circuit (not shown), whereby water is generated. The cathode off-gas containing water vapor is discharged into the supply pipe 146A.

The three-way valve SV5 permits communication between the supply pipes 146A and 146B, and the three-way valve SV6 permits communication between the supply pipes 146B and 146C. The cathode off-gas is supplied to the reformer 112 from the cathode of the HMFC 120 through the supply pipes 146A to 146C. By supplying the cathode off-gas from the HMFC 120 to the reformer 112 where the steam-reforming reaction is carried out, water vapor in the cathode off-gas can be used in the reforming reaction. This decreases the amount of water vapor that needs to be supplied from the outside of the fuel cell system. As a result, the fuel cell system can generate electric power efficiently.

During ordinary operation, cooling air is supplied through the cooling pipe 150 so that the inside of the HMFC 120 is cooled by heat exchange with cooling air in the cooling pipe 150.

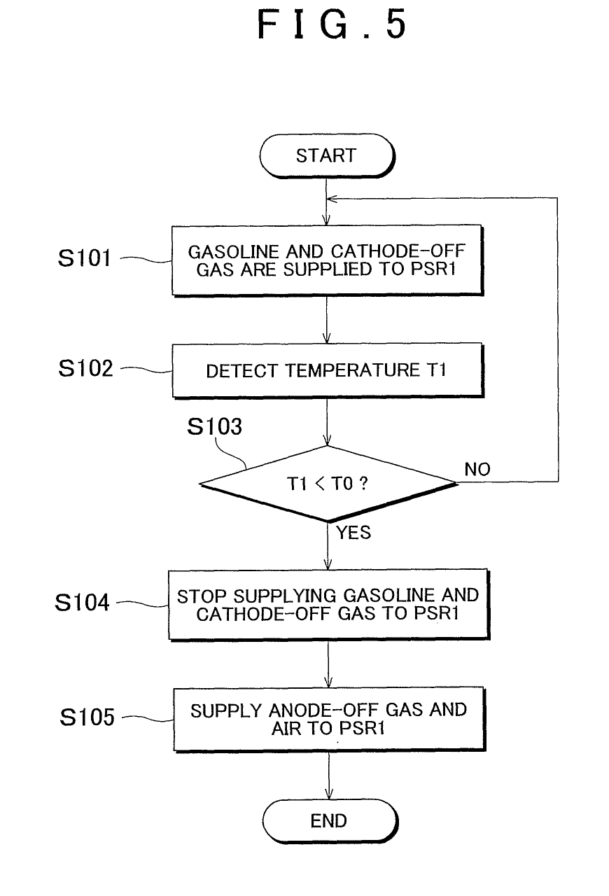

The control of the valves and the pumps to switch the reforming reaction to the recovery reaction (combustion reaction) in the reformer 112 will be described with reference to FIG. 5. FIG. 5 illustrates the flowchart of the control to switch the reforming reaction to the recovery reaction in the reformer 112 in the first embodiment. In FIG. 5, first, the control portion 170 supplies gasoline and the cathode off-gas to the reformer 112 to carry out the reforming reaction in the reformer 112 (PSR1) (step S101). At this time, the anode off-gas mixed with air is supplied to the reformer 114 (PSR2).

The control portion 170 detects, using the temperature sensor 116, a temperature T1 inside the reformer 112 where the reforming reaction is carried out while supplying gasoline and the cathode off-gas to the reformer 112 (step S102).

Next, the control portion 170 determines whether the temperature T1 is lower than a threshold value T0 (for example, approximately 600° C.) (step S103). If the control portion 170 determines that the temperature T1 is equal to or higher than the threshold value T0 (NO in step S103), gasoline and the cathode off-gas are supplied to the reformer 112 in step S101.

If the control portion 170 determines that the temperature T1 is lower than the threshold value T0 (YES in step S103), the control portion 170 stops supplying gasoline and the cathode off-gas to the reformer 112 (step S104). At this time, the control portion 170 also stops supplying the anode off-gas to the reformer 114.

Next, the control portion 170 switches the reforming reaction to the recovery reaction in the reformer 112, and switches the recovery reaction to the reforming reaction in the reformer 114. More specifically, the control portion 170 supplies the anode off-gas mixed with air to the reformer 112 to switch the reforming reaction to the recovery reaction in the reformer 112. The recovery reaction increases the temperature inside the reformer 112, which has decreased by the recovery reaction (combustion reaction). Also, the control portion 170 supplies gasoline and the cathode off-gas to the reformer 114 to switch the recovery reaction to the reforming reaction in the reformer 114 (step S105). Then, the control routine ends.

Only the control to switch the reforming reaction to the recovery reaction in the reformer 112 has been described. However, the same control is executed when the reforming reaction is switched to the recovery reaction in the reformer 114.

Next, the reaction that is carried out when the fuel cell system 100 according to the invention is started will be described. As described above, in the fuel cell system 100 according to the invention, after the warming-up operation is completed, first, gasoline is supplied to the reformer 112 by operating the pump P1. Also, air is supplied to the HMFC 120 by operating the pump P3, and the cathode off-gas discharged from the HMFC 120 is supplied to the reformer 112. At this time, hydrogen has not been supplied to the HMFC 120 yet. Therefore, the amount of water vapor contained in the cathode off-gas is not sufficient for carrying out the steam-reforming reaction. The composition of the cathode off-gas is the same as that of air.

The amount of gasoline supplied to the reformer 112 is slightly excessive with respect to the amount of cathode off-gas supplied to the reformer 112. Therefore, the partial oxidation reaction proceeds in the reformer 112. When hydrogen is generated by this partial oxidation reaction, an electric power generating reaction gradually proceeds in the HMFC 120. As the electric power generating reaction proceeds in the HMFC 120, the amount of oxygen consumed in the cathode of the HMFC 120 increases, and the amount of water vapor contained in the cathode off-gas increases. Accordingly, the partial oxidation reaction gradually switches to the steam-reforming reaction in the reformer 112, and the ordinary operation starts.

As described above, because the fuel cell system is activated by the partial oxidation reaction during system startup, electric power can be generated without obtaining the water vapor necessary for generating hydrogen, from the outside of the fuel cell system. When the partial oxidation reaction is carried out during system startup, or when the ratio of steam (water vapor) to carbon decreases due to the ordinary operation under a high load, soot is likely to be generated. However, in the fuel cell system according to the invention, the soot-trap member removes the soot. Therefore, the fuel cell system can continuously operate.

As described above, in this embodiment, the sulfur-trap member removes the sulfur compounds and the like in gasoline supplied when the reforming reaction is carried out. Also, the soot-trap member removes soot generated by the partial oxidation reaction, from the hydrogen-containing gas. As a result, poisoning of the catalyst with the sulfur compounds and the like can be prevented, and the hydrogen-containing gas that contains few impurities, such as soot, can be supplied to the HMFC 120. This reduces the possibility that the resistance in the gas passages in the reformer increases due to accumulation of the impurities in the reformer. Therefore, the fuel cell system according to the invention can stably supply electric power.

The sulfur compounds and the like that are trapped by the sulfur-trap member are released from the sulfur-trap member by the heat of the gas generated by the recovery reaction (combustion reaction). The sulfur compounds and the like, and the gas generated by the combustion reaction are discharged to the outside of the fuel cell system through a desulfurization device (not shown), and the like. Also, the soot trapped by the soot-trap member is burned using the anode off-gas during the recovery reaction, whereby the recovery reaction is efficiently carried out in the reformer.

The case where gasoline is used as the reactant in the reforming reaction has been described. However, the same configuration can be employed also in the case where hydrocarbon fuel other than gasoline is used.

Next, other examples of the HMFC 120 of the fuel cell system according to the first embodiment will be described with reference to FIG. 6 and FIG. 7. The examples of the HMFC are described in detailed in Japanese Patent Application Publication No. JP-A-2004-146337.

FIG. 6 shows an HMFC 200 that includes an electrolyte membrane 202; an oxygen electrode 204; and a hydrogen electrode 206. The HMFC 200 further includes a metal-diffusion suppression layer 214 and a reaction suppression layer 210. The electrolyte membrane 202 has a five-layer structure, and includes a dense substrate 212 made of vanadium (V). The electrolyte membrane 202 is provided between the oxygen electrode 204 and the hydrogen electrode 206. In the electrolyte membrane 202, the dense metal-diffusion suppression layer 214 and a palladium (Pd) layer 216 are provided on the surface of the substrate 212 facing the hydrogen electrode (anode) 206 in the order stated. Also, the dense reaction suppression layer 210 (for example, a layer of a proton conductor, a mixed conductor, or an insulator), and a thin electrolyte layer 208 made of solid oxide (for example, a layer of metal oxide SrCeO₃, which is one of perovskite) are provided on the surface of the substrate 212 facing the oxygen electrode (cathode) 204, in the order stated. The reaction suppression layer 210 suppresses the reaction between oxygen atoms in the electrolyte layer 208 and the substrate (V) 212. The air passages 180 and hydrogen passages 182 are formed between the electrolyte membrane 202 and the oxygen electrode 204, and between the electrolyte membrane 202 and the hydrogen electrode 206, respectively as in the aforementioned embodiment. As described above, the metal-diffusion suppression layer and the reaction suppression layer are described in detail in the aforementioned publication.

FIG. 7 shows a proton-exchange membrane HMFC 300 that includes an electrolyte membrane 302; an oxygen electrode 304; and a hydrogen electrode 306. The electrolyte membrane 302 is provided between the oxygen electrode 304 and the hydrogen electrode 306. The electrolyte membrane 302 has a multiple layer structure, and includes dense hydrogen-permeable metal layers. For example, in the electrolyte membrane 302, an electrolyte layer 312 is provided between the dense hydrogen-permeable metal layers. The electrolyte layer 312 is composed of a solid polymer membrane, for example, Nafion membrane (registered trademark). A palladium (Pd) layer (dense layer) 314 is provided on the surface of the electrolyte layer 312 that faces the hydrogen electrode (anode) 306. A vanadium-nickel (V—Ni) layer (dense layer) 310, which serves as a substrate, and a Pd layer (dense layer) 308 are provided on the surface of the electrolyte layer 312 that faces the oxygen electrode (cathode) 304, in the order stated. The air passages 180 and the hydrogen passages 182 are formed between the electrolyte membrane 302 and the oxygen electrode 304, and between the electrolyte membrane 302 and the hydrogen electrode 306, respectively as in the aforementioned embodiment. In this HMFC 300 as well, the metal-diffusion suppression layer may be provided between the V—Ni layer 310 and the Pd layer 308. Also, the reaction suppression layer may be provided between the electrolyte layer 312 and the V—Ni layer 310 or the Pd layer 314.

In the proton-exchange membrane fuel cell shown in FIG. 7, a hydrous electrolyte layer may be provided between hydrogen-permeable metal layers. With this configuration, evaporation of water from the electrolyte layer and increases in the membrane resistance at high temperatures can be suppressed. The operating temperature of the proton-exchange membrane fuel cell (PEFC), which is generally low, can be increased to 300 to 600° C. This fuel cell is suitable for the fuel cell system according to the invention where the cathode off-gas discharged from the fuel cell is directly supplied to the PSR reformer where the reaction should be carried out.

While the invention has been described with reference to example embodiment thereof, it should be understood that the invention is not limited to the example embodiments or constructions. To the contrary, the invention is intended to cover various modifications and equivalent arrangements. In addition, while the various elements of the example embodiment are shown in various combinations and configurations, which are exemplary, other combinations and configurations, including more, less or only a single element, are also within the spirit and scope of the invention.

1-8. (canceled)

9. A hydrogen generation device comprising:
a pair of reformers, each of which includes a catalyst, and in each of which a reforming reaction is carried out to generate hydrogen-containing gas using reactant on the catalyst, and an exothermic reaction is carried out to heat and recover the catalyst using exothermic material;
a removing portion that is provided downstream of the catalyst in at least one of the pair of reformers in a direction where the reactant flows, and that removes at least soot; and
a control portion that executes a control such that the reactant and the exothermic material are alternately supplied to each of the pair of reformers, whereby the reforming reaction and the exothermic reaction are alternately carried out in each of the pair of reformers.

10. The hydrogen generation device according to claim 9, wherein an additional removing portion removes at least one of a sulfur compound and a nitrogen compound; and said removing portion is provided upstream of the catalyst in the at least one of the pair of reformers in a direction where the reactant flows.

11. The hydrogen generation device according to claim 9, wherein the exothermic material is supplied in the direction opposite to the direction where the reactant is supplied when the recovery reaction is carried out.

12. The hydrogen generation device according to claim 9, wherein the control portion executes a control such that when the reforming reaction is carried out in one of the pair of reformers, the exothermic reaction is carried out in the other reformer.

13. A fuel cell system comprising:
the hydrogen generation device according to claim 9; and
a fuel cell that generates electric power using the hydrogen-containing gas that is generated by the hydrogen generation device.

14. The fuel cell system according to claim 13, wherein the fuel cell includes a hydrogen-permeable metal layer, and an electrolyte layer that is provided on at least one surface of the hydrogen-permeable metal layer.

15. A hydrogen generation device comprising:
a plurality of reformers, each of which includes a catalyst, and in each of which a reforming reaction is carried out to generate hydrogen-containing gas using reactant on the catalyst, and an exothermic reaction is carried out to heat and recover the catalyst using exothermic material;
a removing portion that is provided downstream of the catalyst in at least one of the plurality of reformers, and that removes at least soot; and
a control portion that executes a control such that the reactant and the exothermic material are alternately supplied to each of the plurality of reformers, whereby the reforming reaction and the exothermic reaction are alternately carried out in each of the plurality of reformers.

16. A hydrogen generation device comprising:
a pair of reformers, each of which includes a catalyst, and in each of which a reforming reaction is carried out to generate hydrogen-containing gas using reactant on the catalyst that has been heated when the reactant is supplied, and an exothermic reaction is carried out to heat and recover the catalyst using exothermic material when the exothermic material is supplied;
a removing portion that is provided downstream of the catalyst in at least one of the pair of reformers in a direction where the reactant flows, and that removes at least soot; and
a control portion that executes a control such that the reactant and the exothermic material are alternately supplied to each of the pair of reformers, whereby the reforming reaction and the exothermic reaction are alternately carried out in each of the pair of reformers.
